(19) United States
(12) Patent Application Publication
(10) Pub. No.: US 2013/0154925 A1
(43) Pub. Date: Jun. 20, 2013

(54) ELECTRONIC APPARATUS AND CONTROL METHOD THEREOF

(71) Applicant: Wistron NeWeb Corp., Hsinchu (TW)

(72) Inventor: CHUN-LIN CHEN, Hsinchu (TW)

(73) Assignee: Wistron NeWeb Corp., Hsinchu (TW)

(21) Appl. No.: 13/654,727

(22) Filed: Oct. 18, 2012

(30) Foreign Application Priority Data
Dec. 16, 2011 (TW) 100146906

(51) Int. Cl. G09G 5/00; G09G 5/08

(52) U.S. Cl. 345/157; 345/156

(57) ABSTRACT

An electronic apparatus and a control method thereof are disclosed. The electronic apparatus includes a receiving module, a judging module, and a display module. The receiving module is used to receive a remote signal transmitted from a remote apparatus. The judging module judges whether the remote signal includes a homing command to generate a judgment result. The display module selectively homes an indicating object displayed on a screen of the display module to a default position on the screen according to the judgment result.

### BACKGROUND OF THE INVENTION

1. Field of the Invention

The invention relates to network browsing; in particular, to an electronic apparatus capable of providing function of homing a network browsing cursor and control method thereof.

2. Description of the Prior Art

With continuous progress of display technology, a new generation of digital television has been on the market to attract the attention of consumers. Since the network is rapidly developed nowadays, the digital televisions are often equipped with network connecting function and have built-in browser for users to browse network to increase the application range of the television to connect network. In general, this type of digital television is called “internet television” or “smart television”.

In fact, when the users use the digital television to browse web pages, they are used to use the remote control to operate the digital television; for example, the user can use arrow keys, touch pad, or track ball of the remote control to control the movement of cursor or click. However, because the size of the monitor of the digital television is quite large, after the user operates the arrow keys, touch pad, or track ball for a period of time, or stays on the web pages for a long time, it is hard for the user to use the arrow keys, touch pad, or track ball again to find the cursor or move the cursor to the wanted position. This is very inconvenient for the user to control the digital television.

### SUMMARY OF THE INVENTION

Therefore, the invention discloses an electronic apparatus and control method thereof to solve the above-mentioned problems.

A first embodiment of the invention is an electronic apparatus. In this embodiment, the electronic apparatus includes a receiving module, a judging module, and a display module. The receiving module is used to receive a remote signal transmitted from a remote apparatus. The judging module is coupled to the receiving module and judges whether the remote signal includes a homing command to generate a judgment result. The display module is coupled to the judging module and selectively homes an indicating object displayed on a screen of the display module to a default position on the screen according to the judgment result.

In an embodiment, the remote apparatus is corresponding to the electronic apparatus and the remote apparatus is operated by a user to generate the remote signal.

In an embodiment, the remote apparatus includes a key corresponding to a cursor homing function, when the user presses the key, the remote apparatus generates the remote signal comprising the homing command.

In an embodiment, the key is a homing function dedicated key or a function switchable key set to correspond to the cursor homing function.

In an embodiment, the remote apparatus includes a touch pad, when the user generates a specific gesture corresponding to the cursor homing function on the touch pad, the remote apparatus generates the remote signal comprising the homing command.

In an embodiment, the specific gesture is to draw a circle. The indicating object is a cursor. The default position on the screen is located at a diagonal center, a corner, or an edge of the screen.

A second embodiment of the invention is an electronic apparatus control method. In this embodiment, the electronic apparatus control method includes steps of (a) receiving a remote signal transmitted from a remote apparatus; (b) judging whether the remote signal comprises a homing command to generate a judgment result; (c) selectively homing an indicating object displayed on a screen of the electronic apparatus to a default position on the screen according to the judgment result.

Compared to the prior arts, the electronic apparatus and control method thereof disclosed by the invention will provide the user more user-friendly way to control. When the user uses remote control to browse the web page screen displayed on the monitor of the digital television, the user only needs to press a homing function dedicated key or a function switchable key set to correspond to the cursor homing function, or generate a specific gesture (e.g., a gesture of drawing a circle) on the touch pad, then the cursor on the web page screen displayed on the monitor of the digital television can be homed to a default position on the screen to meet the user's operating habits and convenient for the user to operate. By doing so, when the user uses the remote control to browse the web page screen displayed on the monitor of the digital television, it is easier for the user to find the cursor or move the cursor to the wanted position.

The advantage and spirit of the invention may be understood by the following detailed descriptions together with the appended drawings.

### BRIEF DESCRIPTION OF THE APPENDED DRAWINGS

FIG. 1 illustrates a function block diagram of the electronic apparatus in an embodiment of the invention.

FIG. 2A and FIG. 2B illustrate schematic diagrams of the user pressing the homing function dedicated key and the homing of the network browsing cursor displayed by the electronic apparatus respectively.

FIG. 3A and FIG. 3B illustrate schematic diagrams of the user pressing a function switchable key of the remote apparatus set to correspond to the cursor homing function and the homing of the network browsing cursor displayed by the electronic apparatus respectively.

FIG. 4A and FIG. 4B illustrate schematic diagrams of the user generating a specific gesture on the touch pad of the remote apparatus and the homing of the network browsing cursor displayed by the electronic apparatus respectively.

FIG. 5 shows the flowchart of the electronic apparatus control method in another embodiment of the invention.

### DETAILED DESCRIPTION OF THE INVENTION

A first embodiment of the invention is an electronic apparatus. In this embodiment, the electronic apparatus is preferably a digital television equipped with network connecting function and built in browser for users to browse network; for example, the so-called “internet television” or “smart television”, but not limited to this. In addition, the electronic apparatus has remote function, and the user can a remote apparatus corresponding to the electronic apparatus to control the electronic apparatus.

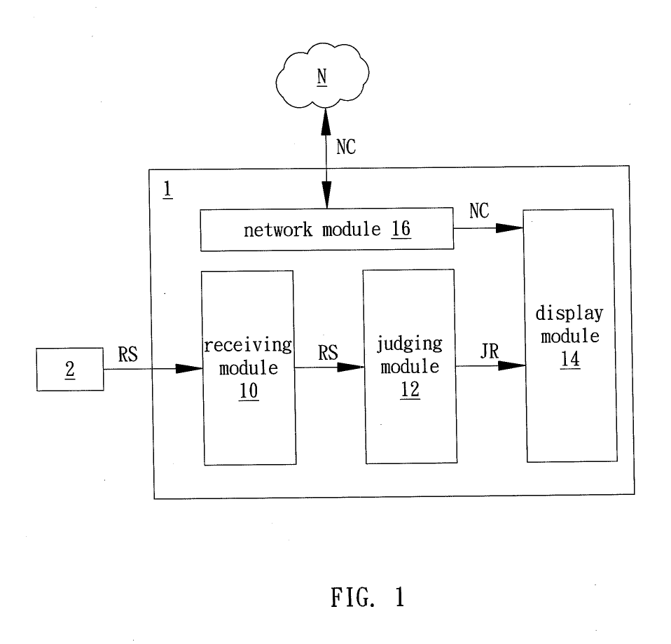

Please refer to FIG. 1. FIG. 1 illustrates a function block diagram of the electronic apparatus in this embodiment. As shown in FIG. 1, the electronic apparatus 1 includes a receiving module 10, a judging module 12, a display module 14, and a network module 16. Wherein, the receiving module 10 is coupled to the judging module 12; the judging module 12 is coupled to the display module 14; the network module 16 is coupled to the display module 14 and the network N.

In this embodiment, the electronic apparatus 1 connects to the network N via the network module 16, and receives a network information content NC from the network N; for example, the web page screen, but not limited to this. Then, after the network module 16 transmits the network information content NC to the display module 14, the display module 14 will display the network information content NC via the built-in browser for the user to browse. In general, the screen displayed on the display module 14 includes not only the network information content NC, but also an indicating object, such as a network browsing cursor, to be convenient for the user to browse network or click.

The receiving module 10 is used to receive a remote signal RS transmitted from the remote apparatus 2. In fact, the remote apparatus 2 can be a remote control corresponding to the electronic apparatus 1 and the remote apparatus 2 is operated by the user to generate the remote signal RS. For example, if the electronic apparatus 1 is a digital television having network browsing function, then the remote apparatus 2 is a television remote control corresponding to the digital television. The user can use the television remote control to control the functions of the digital television, such as turn-on, shutdown, volume, display mode, and network browsing cursor.

It should be mentioned that the purpose of the invention is to provide a function of homing the network browsing cursor of the digital television; therefore, after the receiving module 10 receives the remote signal RS transmitted from the remote apparatus 2, the judging module 12 will judge whether the remote signal RS includes a homing command to generate a judgment result JR to the display module 14. That is to say, the judgment result JR generated by the judging module 12 may have two possible conditions: one possible condition is that the remote signal RS includes a homing command, it means that the user wants to use the function of homing the network browsing cursor of the electronic apparatus 1; the other possible condition is that the remote signal RS does not include any homing command, it means that the user wants to use other functions of the electronic apparatus 1, such as turn-on, shutdown, adjusting volume, switching different display modes.

After the display module 14 receives the judgment result JR from the judging module 12, the display module 14 will selectively home an indicating object (e.g., a cursor) displayed on a screen of the display module 14 to a default position on the screen according to the judgment result JR to achieve the function of homing the network browsing cursor. That is to say, if the judgment result JR is that the remote signal RS includes the homing command, the indicating object (e.g., the cursor) displayed on the screen of the display module 14 will be homed to the default position on the screen; if the judgment result JR is that the remote signal RS does not include the homing command, the indicating object (e.g., the cursor) displayed on the screen of the display module 14 will perform other functions of the electronic apparatus 1, such as turn-on, shutdown, adjusting volume, switching different display modes, according to the remote signal RS instead of being homed to the default position on the screen.

In fact, the default position that the indicating object is homed to can be any positions on the screen, and it can be set by system in advance or set by the user without specific limitations. For example, the default position that the indicating object is homed can be located at a diagonal center, a corner, or an edge of the screen. It can be adjusted by the users according to their own habits.

Next, several embodiments will be used to introduce how the user uses the remote apparatus 2 to control the network browsing cursor displayed on the display module 14 of the electronic apparatus 1 to be home.

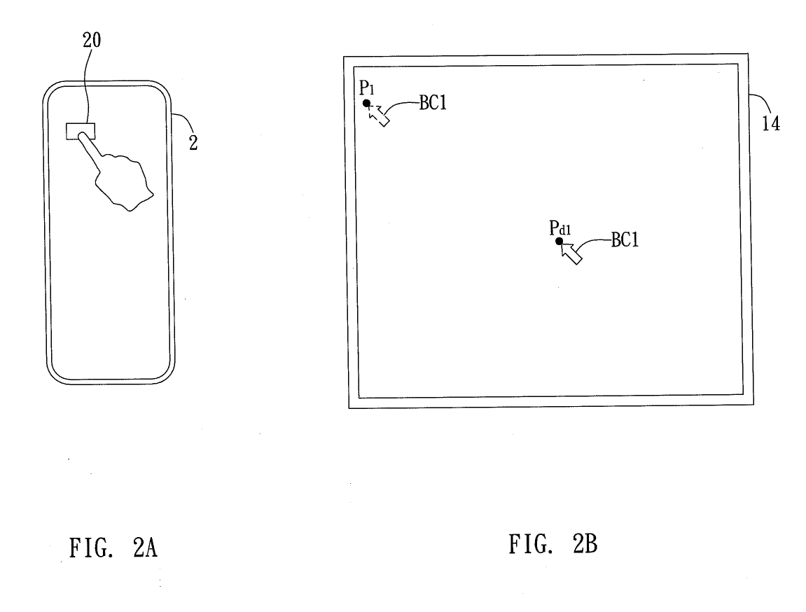

Please refer to FIG. 2A and FIG. 2B. FIG. 2A and FIG. 2B illustrate schematic diagrams of the user pressing the homing function dedicated key and the homing of the network browsing cursor displayed by the electronic apparatus respectively. As shown in FIG. 2B, it is assumed that the network browsing cursor BC₁ (in dashed lines) originally displayed on the display module 14 of the electronic apparatus 1 is located at a first position P₁ on the screen. As shown in FIG. 2A, a homing function dedicated key 20 is disposed on the remote apparatus 2. When the user presses the homing function dedicated key 20, the remote apparatus 2 will transmit the remote signal RS including the homing command to the electronic apparatus 1. After the receiving module 10 of the electronic apparatus 1 receives the remote signal RS transmitted from the remote apparatus 2, the judging module 12 will judge that the remote signal RS including the homing command and generate the judgment result JR that the remote signal RS including the homing command to the display module 14. Then, as shown in FIG. 2B, the display module 14 will home the network browsing cursor BC₁ displayed on the screen of the display module 14 from the first position P₁ to a first default position Pd₁ according to the judgment result JR that the remote signal RS including the homing command. In this case, the first default position Pd₁ is the diagonal center of the screen displayed on the display module 14, but not limited to this.

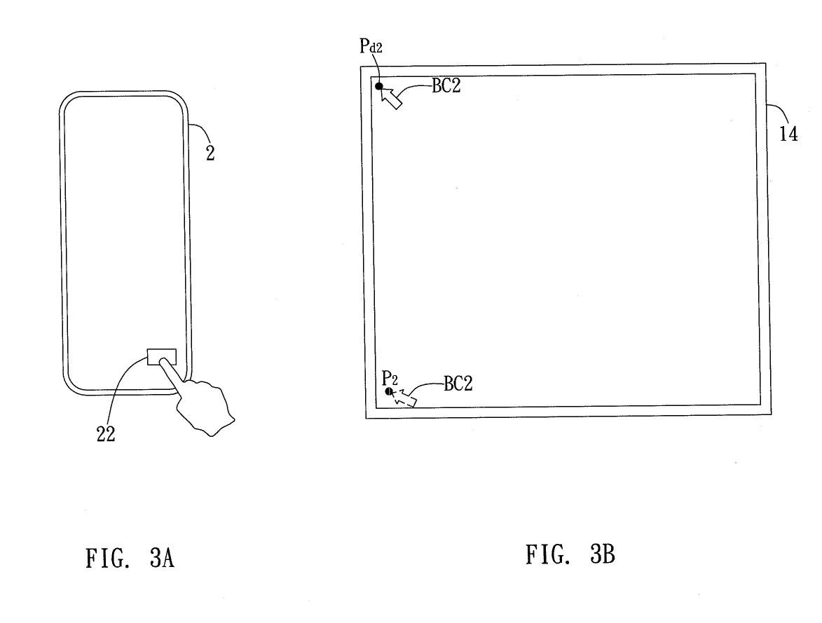

Please refer to FIG. 3A and FIG. 3B. FIG. 3A and FIG. 3B illustrate schematic diagrams of the user pressing a function switchable key of the remote apparatus set to correspond to the cursor homing function and the homing of the network browsing cursor displayed by the electronic apparatus respectively. As shown in FIG. 3B, it is assumed that the network browsing cursor BC₂ (in dashed lines) originally displayed on the display module 14 of the electronic apparatus 1 is located at a second position P₂ on the screen. As shown in FIG. 3A, a function switchable key 22 is disposed on the remote apparatus 2 and set to correspond to the cursor homing function. When the user presses the function switchable key 22 corresponding to the cursor homing function, the remote apparatus 2 will transmit the remote signal RS including the homing command to the electronic apparatus 1. After the receiving module 10 of the electronic apparatus 1 receives the remote signal RS transmitted from the remote apparatus 2, the judging module 12 will judge that the remote signal RS including the homing command and generate the judgment result JR that the remote signal RS including the homing command to the display module 14. Then, as shown in FIG. 3B, the display module 14 will home the network browsing cursor BC₂ displayed on the screen of the display module 14 from the second position P₂ to a second default position Pd₂ according to the judgment result JR that the remote signal RS including the homing command. In this case, the second default position Pd₂ is the upper left corner of the screen displayed on the display module 14, but not limited to this.

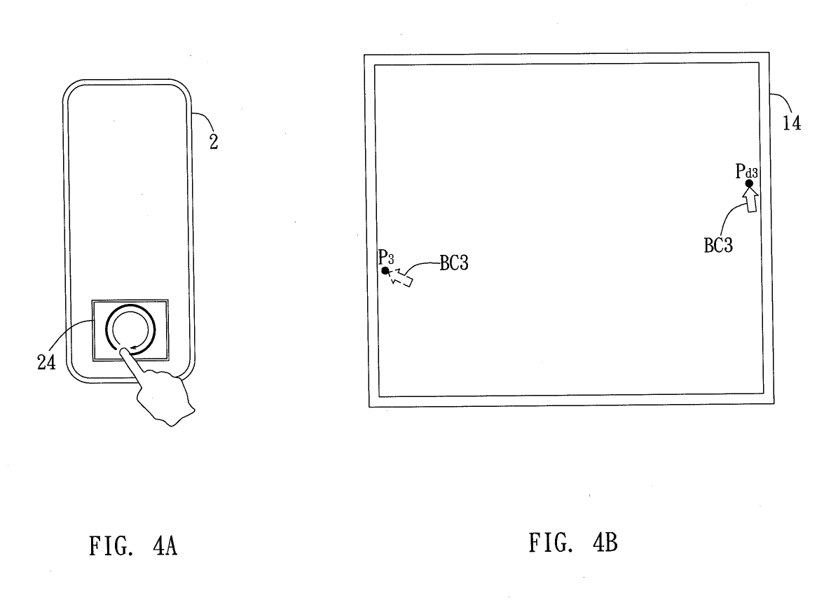

Please refer to FIG. 4A and FIG. 4B. FIG. 4A and FIG. 4B illustrate schematic diagrams of the user generating a specific gesture on the touch pad of the remote apparatus and the homing of the network browsing cursor displayed by the electronic apparatus respectively. As shown in FIG. 4B, it is assumed that the network browsing cursor BC₃ (in dashed lines) originally displayed on the display module 14 of the electronic apparatus 1 is located at a third position P₃ on the screen. As shown in FIG. 4A, a touch pad 24 is disposed on the remote apparatus 2. When the user generates a specific gesture corresponding to the cursor homing function (a gesture of drawing a circle in this case, but not limited to this) on the touch pad 24 of the remote apparatus 2, the remote apparatus 2 will transmit the remote signal RS including the homing command to the electronic apparatus 1. After the receiving module 10 of the electronic apparatus 1 receives the remote signal RS transmitted from the remote apparatus 2, the judging module 12 will judge that the remote signal RS including the homing command and generate the judgment result JR that the remote signal RS including the homing command to the display module 14. Then, as shown in FIG. 4B, the display module 14 will home the network browsing cursor BC₃ displayed on the screen of the display module 14 from the third position P₃ to a third default position Pd₃ according to the judgment result JR that the remote signal RS including the homing command. In this case, the third default position Pd₃ is the right edge of the screen displayed on the display module 14, but not limited to this.

A second embodiment of the invention is an electronic apparatus control method. In this embodiment, the electronic apparatus control method is used to control an electronic apparatus. The electronic apparatus is preferably a digital television equipped with network connecting function and built in browser for users to browse network; for example, the so-called “internet television” or “smart television”, but not limited to this. In addition, the electronic apparatus has remote function, and the user can a remote apparatus corresponding to the electronic apparatus to control the electronic apparatus.

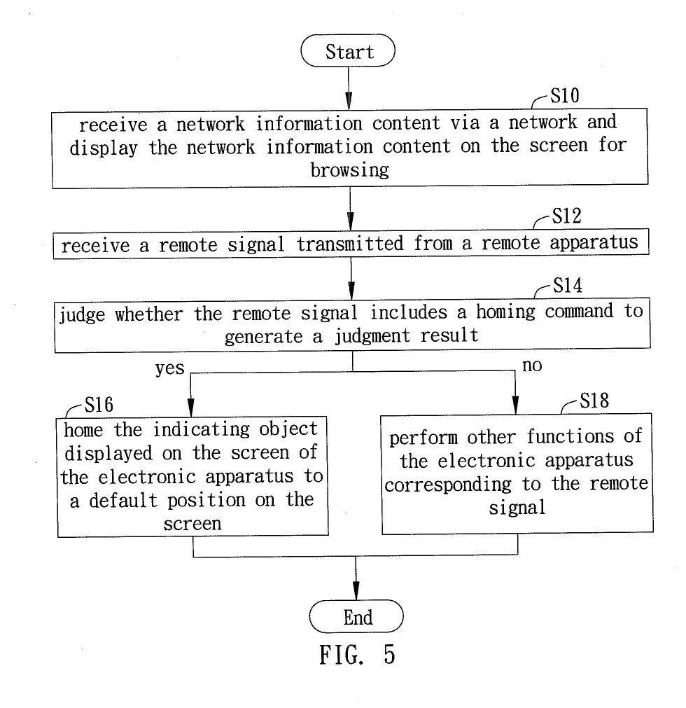

Please refer to FIG. 5. FIG. 5 shows the flowchart of the electronic apparatus control method in this embodiment. As shown in FIG. 5, at first, the step S10 is performed to receive a network information content via a network and display the network information content on the screen for browsing. In general, the screen displayed on the built-in browser of the electronic apparatus includes not only the network information content, but also an indicating object, such as a network browsing cursor, to be convenient for the user to browse network or click.

Then, the step S12 is performed to receive a remote signal transmitted from a remote apparatus. In fact, the remote signal is generated by the remote apparatus operated by an operation of a user. The operation is to press a key of the remote apparatus or to generate a specific gesture corresponding to the cursor homing function on a touch pad of the remote apparatus, such as the gesture of drawing a circle.

Then, the step S14 is performed to judge whether the remote signal includes a homing command to generate a judgment result. If the judgment result of the step S14 is yes, it means that the remote signal includes the homing command and the user wants to use the network browsing cursor homing function of the electronic apparatus. At this time, the step S16 is performed to home the indicating object displayed on the screen of the electronic apparatus to a default position on the screen.

If the judgment result of the step S14 is no, it means that the user wants to use other functions of the electronic apparatus, such as turn-on, shutdown, adjusting volume, switching different display modes. Therefore, in the step S18, the method will perform other functions of the electronic apparatus corresponding to the remote signal.

Compared to the prior arts, the electronic apparatus and control method thereof disclosed by the invention will provide the user more user-friendly way to control. When the user uses remote control to browse the web page screen displayed on the monitor of the digital television, the user only needs to press a homing function dedicated key or a function switchable key set to correspond to the cursor homing function, or generate a specific gesture (e.g., a gesture of drawing a circle) on the touch pad, then the cursor on the web page screen displayed on the monitor of the digital television can be homed to a default position on the screen to meet the user's operating habits and convenient for the user to operate. By doing so, when the user uses the remote control to browse the web page screen displayed on the monitor of the digital television, it is easier for the user to find the cursor or move the cursor to the wanted position.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An electronic apparatus, comprising:
a receiving module, used to receive a remote signal transmitted from a remote apparatus;
a judging module, coupled to the receiving module, the judging module judging whether the remote signal comprises a homing command to generate a judgment result; and
a display module, coupled to the judging module, the display module selectively homing an indicating object displayed on a screen of the display module to a default position on the screen according to the judgment result.

2. The electronic apparatus of claim 1, wherein the remote apparatus is corresponding to the electronic apparatus and the remote apparatus is operated by a user to generate the remote signal.

3. The electronic apparatus of claim 2, wherein the remote apparatus comprises a key corresponding to a cursor homing function, when the user presses the key, the remote apparatus generates the remote signal comprising the homing command.

4. The electronic apparatus of claim 3, wherein the key is a homing function dedicated key or a function switchable key set to correspond to the cursor homing function.

5. The electronic apparatus of claim 2, wherein the remote apparatus comprises a touch pad, when the user generates a specific gesture corresponding to the cursor homing function on the touch pad, the remote apparatus generates the remote signal comprising the homing command.

6. The electronic apparatus of claim 5, wherein the specific gesture is to draw a circle.

7. The electronic apparatus of claim 1, wherein the indicating object is a cursor.

8. The electronic apparatus of claim 1, wherein the default position on the screen is located at a diagonal center, a corner, or an edge of the screen.

9. The electronic apparatus of claim 1, further comprising:
a network module, coupled to the display module and a network, the network module receiving a network information content via the network and transmitting the network information content to the display module, and the display module displaying the network information content on the screen for browsing.

10. A method of controlling an electronic apparatus, comprising the steps of:
(a) receiving a remote signal transmitted from a remote apparatus;
(b) judging whether the remote signal comprises a homing command to generate a judgment result; and
(c) selectively homing an indicating object displayed on a screen of the electronic apparatus to a default position on the screen according to the judgment result.

11. The method of claim 10, wherein the remote signal is generated by the remote apparatus operated by an operation of a user.

12. The method of claim 11, wherein the operation is to press a key of the remote apparatus or to generate a specific gesture corresponding to the cursor homing function on a touch pad of the remote apparatus.

13. The method of claim 12, wherein the specific gesture is to draw a circle.

14. The method of claim 10, wherein the indicating object is a cursor.

15. The method of claim 10, wherein the default position on the screen is located at a diagonal center, a corner, or an edge of the screen.

16. The method of claim 10, further comprising the step of:
receiving a network information content via a network and displaying the network information content on the screen for browsing.
